(19) United States
(12) Patent Application Publication
(10) Pub. No.: US 2017/0129814 A1
(43) Pub. Date: May 11, 2017

(54) BATCH FOR MANUFACTURING A REFRACTORY CERAMIC PRODUCT, METHOD FOR APPLYING A GUNNING MASS OR CASTING MASS ONTO A SURFACE, METHOD FOR MANUFACTURING A REFRACTORY CERAMIC PRODUCT, A REFRACTORY CERAMIC PRODUCT, AND THE USE OF A BATCH

(71) Applicant: Refractory Intellectual Property GmbH & Co. KG, Wien (AT)

(72) Inventors: Alexander Cepak, Wien (AT); Manfred Kappel, Leoben (AT); Karl-Michael Zettl, Wien (AT)

(21) Appl. No.: 15/320,941

(22) PCT Filed: Aug. 10, 2015
(86) PCT No.: PCT/EP2015/068353

§ 371 Date: Dec. 21, 2016

(30) Foreign Application Priority Data
Sep. 11, 2014 (EP) 14184346.6

(51) Int. Cl. C04B 35/047; B28B 1/14; B28B 11/24; C04B 35/622; C04B 35/64

(52) U.S. Cl. CPC C04B 35/0473; C04B 35/62222; C04B 35/64; B28B 11/243; B28B 1/14; C04B 2235/3206; C04B 2235/3241; C04B 2235/5436; C04B 2235/5427; C04B 2235/602; C04B 2235/9607

(57) ABSTRACT

The invention concerns a batch for manufacturing a refractory ceramic product, a method for applying a gunning mass or casting mass to a surface, a method for manufacturing a refractory ceramic product, a refractory ceramic product as well as the use of a batch.

The invention relates to a batch for manufacturing a refractory ceramic product, to a method for applying a gunning mass or casting mass to a surface, to a method for manufacturing a refractory ceramic product, to a refractory ceramic product, and to the use of a batch.

In known manner, a “batch” describes a composition formed from one or more components from which a refractory ceramic product can be manufactured by means of ceramic firing.

The term “refractory ceramic product” as used in the context of the invention in particular describes ceramic products with a service temperature of more than 600° C., and preferably refractory materials in accordance with DIN 51060, i.e. materials with a pyrometric cone equivalent>SK 17. The pyrometric cone equivalent can in particular be determined in accordance with DIN EN 993-12.

Refractory ceramic products are known in the form of unshaped or shaped refractory products.

Shaped refractory ceramic products may be bricks or functional products.

Unshaped refractory ceramic products are also known as so-called “refractory masses”. In particular, unshaped refractory ceramic products or refractory masses are used as casting masses, pumping masses and ramming masses. A further use for a refractory material is as a gunning mass, used to repair high-load regions of a furnace.

The requirements with which refractory ceramic products have to comply as regards their refractory properties are severe. Thus, for example, they must have good refractory thermal properties, for example as high a strength as possible.

Gunning masses and casting masses are known from the prior art, in particular in the form of basic gunning masses. These basic gunning masses and casting masses usually consist of a base component in the form of sintered magnesia and other refractory additives, for example in the form of a chromium oxide material. After applying a gunning mass or casting mass of this type to a surface, when using the product onto the surface of which the mass has been applied, the temperature which is applied to it is such that the mass is sintered into a refractory ceramic product. The sintering capability of a gunning mass or casting mass based on sintered magnesia can be increased by using a further component in the form of said chromium oxide raw material. In this regard, the chromium oxide raw material can in particular form a binder matrix by means of which the grains of sintered magnesia are fused together.

In principle, appropriately constituted gunning masses and casting masses based on sintered magnesia with an added chromium oxide raw material have proved their worth in the manufacture of unshaped refractory ceramic products.

However, improved refractory thermal properties would be desirable for many applications in particular, for example, improved compression strengths of the refractory ceramic products produced from the mass.

The object of the invention is to provide a batch for manufacturing a refractory ceramic product, i.e. a shaped refractory ceramic product or a refractory mass, wherein a refractory ceramic product with improved refractory thermal properties compared with products of this type which are known in the art can be manufactured.

A further object of the invention is to provide a method for manufacturing a refractory ceramic product of this type.

A further object of the invention is to provide a refractory ceramic product with such improved refractory properties.

The first-mentioned object is achieved in accordance with the invention by providing a batch for manufacturing a refractory ceramic product, comprising the following components in the following proportions by weight, respectively with respect to the total weight of the product:
50% to 99.5% by weight of fused magnesia;
0 to 50% by weight of sintered magnesia;
0.5% to 5% by weight of a chromium oxide component in the form of at least one raw material based on Cr₂O₃; wherein
at least 90% by weight of the chromium oxide component has a grain size of at most 50 μm, with respect to the total weight of the chromium oxide component.

Surprisingly, in the context of the invention, it has been shown that based on a batch constituted in this manner, a shaped as well as an unshaped refractory ceramic product, i.e. a refractory mass, can be obtained which exhibits substantially improved thermal properties compared with products which are known in the art.

The batch of the invention differs from batches of the same type which are known in the art firstly, in particular, in that the base component thereof is exclusively or primarily fused magnesia, in contrast to the base component which is usually used in the art for batches of this type, namely sintered magnesia. Secondly, the batch of the invention differs in that a highly specific proportion by weight of fused and sintered magnesia and a chromium oxide component are employed. Furthermore, the batch of the invention also differs in particular in that in it, the chromium oxide component is present in a very fine specific grain size of predominantly at most 50 μm. In this regard, the chromium oxide component of the batch of the invention has a substantially smaller grain size than the chromium oxide components of prior art batches of the same type. In this regard, the grain size of the chromium oxide component in prior art batches of the same type is predominantly more than 100 μm, in particular usually predominantly a grain size in the range 100 μm to 1000 μm.

Surprisingly, in accordance with the invention, it has been shown that the refractory properties of a refractory ceramic product manufactured from a batch of the same type can be significantly improved when the chromium oxide component in the invention has a small grain size. In particular, it has been shown that the figures for a refractory ceramic product as regards its thermal properties, in particular as regards its hot bending strength, linear change of length and cold compression strength can be significantly improved if the chromium oxide component of the mass is present in the small grain size according to the invention. These refractory properties of a refractory ceramic product produced from the batch of the invention can be further improved when at least 90% by weight of the chromium oxide component of the batch of the invention has a grain size of 1 to 50 μm, 2 to 50 μm, 3 to 50 μm, 4 to 50 μm or 5 to 50 μm, respectively with respect to the total weight of the chromium oxide component.

The inventors assume that this advantageous effect of the small grain size of the chromium oxide component is due to the fact that this component reacts particularly intensely with the base component in the form of fused magnesia to form, in the contact zone between the fused magnesia and chromium oxide component, MgO—Cr₂O₃-spinel (picrochromite), whereupon a particularly solid sintered microstructure for the ceramic product is produced.

Furthermore, in accordance with the invention, it has been established that the improved refractory properties of a refractory ceramic product produced from the batch of the invention are in particular adjusted if the base component is primarily or exclusively in the form of fused magnesia and only has a small proportion or zero sintered magnesia. Using a base component in accordance with the invention primarily or exclusively in the form of fused magnesia means that a refractory ceramic product manufactured from the batch of the invention exhibits particularly good corrosion and erosion resistance.

In accordance with the invention, it has been established that upon ceramic firing of the batch of the invention, magnesia-chromite-spinels are formed which have a very positive effect on the thermal properties of a product in accordance with the invention manufactured from the batch. The microstructure of the refractory product is strengthened by the magnesia-chromite-spinel, whereupon the magnesia grains are bound into the microstructure in a particularly strong manner.

In particular, the corrosion and erosion resistance of a refractory ceramic product manufactured from the batch of the invention can be further improved when the fused magnesia is present in the batch of the invention in a proportion of at least 60% by weight including, for example, in a proportion of at least 65%, 70%, 75%, 80%, 85%, 90%, 91%, 92%, 93%, 94%, 95%, 95.5% or 96% by weight, wherein the maximum proportion of the chromium oxide component in the batch in the case of the last two proportions which were mentioned are respectively reduced to at most 4.5% or 4% by weight.

Furthermore, it has been shown in accordance with the invention that the refractory properties of the refractory ceramic product manufactured from the batch of the invention as regards its resistance in particular can be further increased if the proportion of the chromium oxide component in the batch is increased to proportions of at least 0.8% or 1.0% by weight, wherein the maximum proportions of the fused magnesia in the batch is concomitantly restricted to a maximum of 99.2% or 99.0% by weight.

The proportion of sintered magnesia in the base component may be 0% by weight, but can also be a maximum of 50% by weight including, for example, a maximum of 40%, 35%, 30%, 25%, 20%, 15%, 10%, 9%, 8%, 7%, 6%, 5%, 4%, 3%, 2% or 1% by weight.

All data given here as a weight % are with respect to the total weight of the batch of the invention or the product of the invention, unless otherwise stated in individual cases.

The fused magnesia in the batch of the invention may in principle be in the form of any fused magnesia, preferably as ultrapure fused magnesia, particularly preferably with a proportion by weight of MgO of at least 95%, 96%, 97%, 98% or 99% by weight, respectively with respect to the total weight of the fused magnesia.

Preferably, a fused magnesia with as small a proportion as possible of CaO is used, preferably with a proportion of CaO of less than 3% by weight, less than 2.5% by weight, less than 2% by weight, less than 1.5% by weight, less than 1% by weight or less than 0.5% by weight, respectively with respect to the total weight of the fused magnesia.

Preferably, at least 90% by weight of the fused magnesia of the batch has a grain size of at most 5.0 mm, with respect to the total weight of the fused magnesia.

The chromium oxide component in the batch of the invention is particularly preferably in the form of at least one of the following chromium oxide raw materials: ultrapure synthetic chromium oxide raw material or chromium oxide raw material with a proportion of Cr₂O₃ of at least 90% by weight, the latter with respect to the chromium oxide raw material.

Particularly preferably, the chromium oxide component of the batch of the invention is selected exclusively from these chromium oxide raw materials.

The ultrapure synthetic chromium oxide raw material may in particular be an ultrapure technical chromium oxide raw material, for example pigment quality. In particular, the ultrapure synthetic chromium oxide raw material may be an eskolaite material. Ultrapure synthetic chromium oxide raw materials of this type may have a proportion of Cr₂O₃ of more than 90% by weight with respect to the chromium oxide raw material including, for example, more than 92%, 94%, 96%, 98% or 99% by weight of Cr₂O₃. Preferably, the chromium oxide raw materials with a proportion of Cr₂O₃ of at least 90% by weight, may also have a proportion of Cr₂O₃ of at least 92%, 94%, 96%, 98% or 99% by weight of Cr₂O₃, respectively with respect to the chromium oxide raw material.

Preferably, the chromium oxide component comprises a proportion of CaO of less than 1.0% by weight with respect to the chromium oxide component including, for example, less than 0.5% or 0.1% by weight.

In the context of the invention, it has been established that the refractory properties of a refractory ceramic product manufactured from the batch of the invention can be significantly impaired if the total CaO content in the batch of the invention is at least 2% by weight. In this regard, in accordance with the invention, the CaO content in the batch of the invention is set at less than 2.0% by weight, preferably including, for example, less than 1.5% by weight, 1.0% by weight, 0.7% by weight, 0.5% by weight or less than 0.3% by weight.

Since quantities of CaO are in particular introduced into the batch through impurities in the raw materials, the invention preferably provides that ultrapure magnesia raw material as well as ultrapure chromium oxide components are employed.

Furthermore, the following oxides, used individually or in combination, are preferably present in the batch in less than the following proportions by weight:
Al₂O₃: less than 3%, less than 2% or less than 1% by weight;
SiO₂: less than 3%, less than 2% or less than 1% by weight;
Fe₂O₃: less than 3%, less than 2% or less than 1% by weight;
TiO₂: less than 3%, less than 2% or less than 1% by weight.

As mentioned above, the batch of the invention preferably comprises pure to ultrapure components. In this regard, the proportion of MgO in the batch can completely or essentially correspond to the proportion of fused magnesia and the proportion of Cr₂O₃ in the batch can completely or essentially correspond to the proportion of the chromium oxide component. In this regard, for example, the batch may preferably comprise the following proportions of MgO and Cr₂O₃, individually or in combination:
MgO: 95% to 95.5% by weight including, for example, at least 95.5% by weight or 96% by weight and, for example, including at most 99.0% by weight or 98.5% by weight;
Cr₂O₃: 0.5% by weight to 5% by weight including, for example, at least 1.0% by weight or 1.5% by weight and, for example, including at most 4.5% by weight or 4.0% by weight.

The batch may also comprise at least one plasticizer as a further component. Plasticizers of this type, which are also known as elasticizers, are known in the art and serve to increase the elasticity of the microstructure of the fired refractory ceramic product. In principle, any known prior art plasticizer may be present in the batch of the invention, for example spinel, hercynite, galaxite or jacobsite. As an example, plasticizers may be present in the batch in proportions in the range 0.1% to 0.5% by weight.

The batch of the invention may be used in known prior art technologies as a mass, for example as a pumping or ramming mass. In accordance with the invention, it has been shown, however, that the batch of the invention can be used in a particularly advantageous manner as a casting mass or gunning mass, in particular when employing known prior art technologies. In this regard, the batch of the invention may, for example, be provided with inorganic binders, for example sulphate or phosphate binders, for example at least one of the following binders: sodium hexametaphosphate or sodium bisulphate. As an example, the batch may comprise binders in a proportion in the range 0.5% to 5% by weight, with the mass of the batch of the invention without the binder representing 100% by weight.

In the event that it is used as a refractory mass, the batch, if appropriate provided with binders, may then be applied to a desired location or a desired surface using technology which is known in the art. In this regard, if the batch is used as a gunning mass, the batch may, for example, be blended with water and, for example, be applied to the tap hole in a steel production converter.

The invention further provides a method for applying a mass to a surface, having the following characteristics:
providing the batch in accordance with the invention;
applying the batch to a surface.

Furthermore, the method may comprise the steps of the method described herein.

The invention also provides a method for manufacturing a refractory ceramic product in which, after applying it to the surface, the batch undergoes ceramic firing and is fired to form a refractory ceramic product.

Normally, ceramic firing of a gunning mass or casting mass is carried out by heating the gunning mass or casting mass applied to a surface upon use of the product onto the surface of which the gunning mass has been applied. In this manner, the gunning mass or casting mass is sintered to form a refractory ceramic, i.e. sintered product.

Instead of being used as a refractory mass, the batch of the invention may be used for the manufacture of a shaped refractory ceramic product; in this case, known prior art technologies can be used. In this regard, the batch of the invention may, for example, be provided with inorganic or organic binders, for example inorganic sulphate or phosphate binders or organic binders in the form of lignin sulphonates, for example in a proportion in the range 0.5% to 5% by weight with the weight of the batch of the invention without binder constituting 100% by weight. Next, the batch blended with a binder can be mixed and finally shaped into a shaped article, known as a green compact. After prior drying if appropriate, the green compact can then finally undergo ceramic firing and thus be fired to form a shaped refractory ceramic product, in particular in a furnace.

The invention further provides a method for manufacturing a shaped refractory ceramic product which may comprise the steps of the method described herein.

Ceramic firing of the batch may in particular be carried out at a temperature in the temperature range of 1300° C. to 1750° C., particularly preferably at least 1350° C. or 1380° C. and at most 1700° C., 1650° C., 1600° C., 1550° C., 1500° C., 1450° C. or 1420° C., since in accordance with the invention, it has been shown that at these temperatures, products in accordance with the invention which have been fired in these temperature ranges exhibit particularly good thermal properties, for example particularly good hot bending strength, bending strength, cold compression strength and linear change of length properties.

The invention also pertains to a refractory ceramic product which is manufactured by a method in accordance with the invention. A refractory ceramic product manufactured in accordance with the method of the invention based on the batch of the invention as mentioned above is characterized by outstanding refractory thermal properties. In particular, a product of this type exhibits outstanding hot bending strength, outstanding linear change of length properties as well as outstanding cold compression strength.

Thus, the hot bending strength of the product of the invention may, for example, be at least 0.5 N/mm² including, for example, at least 0.6 N/mm², 0.7 N/mm² or 0.8 N/mm². The hot bending strength is determined in accordance with DIN EN 993-7: 1998 at 1400° C. in an oxidizing atmosphere.

The bending strength of the product of the invention may, for example, be at least 5 or 6 N/mm². The bending strength is determined in accordance with DIN EN 993-11: 2007.

The cold compression strength of the product of the invention may, for example, be at least 15 N/mm² including, for example, at least 16, 18, 20 or 22 N/mm². The cold compression strength is determined in accordance with DIN EN 993-5: 1998.

The linear change of length of the product of the invention may, for example, be at most −0.15 linear % including, for example, at most −0.14 linear %. The linear change of length is determined in accordance with DIN 51045-5: 2007-01.

The use of the batch of the invention as a refractory gunning mass or casting mass also constitutes an object of the invention, as described herein.

The invention may be used in accordance with its disclosed characteristics.

Further features of the invention are contained in the claims and in the description below of an exemplary embodiment of the invention.

All of the features of the invention disclosed herein may be combined together in any manner, either individually or in combination.

An exemplary embodiment of the invention will now be described in more detail. The exemplary embodiment concerns a batch in accordance with the invention which was treated in accordance with the method of the invention and was used as a gunning mass.

Firstly, a batch was produced which comprised 97.08% by weight of fused magnesia and 2.92% by weight of a chromium oxide component in the form of an ultrapure synthetic chromium oxide raw material in the form of chrome oxide green.

The fused magnesia was used in an ultrapure form with a proportion of MgO of approximately 97.63% by weight with respect to the total weight of fused magnesia. Finally, the fused magnesia comprised proportions of the following oxides, respectively with respect to the total weight of fused magnesia: 0.08% by weight of Al₂O₃; 0.26% by weight of SiO₂; 0.19% by weight of Fe₂O₃; 1.8% by weight of CaO; 0.04% by weight of B₂O₃.

The chrome oxide green used was also in the ultrapure form with a proportion of Cr₂O₃ of approximately 99% by weight with respect to the total weight of chrome oxide green. In addition, the chrome oxide green contained the following other oxides, in each case with respect to the total weight of chrome oxide green: 0.05% by weight of Al₂O₃; 0.05% by weight of SiO₂; 0.05% by weight of Fe₂O₃; 0.2% by weight of CaO; 0.05% by weight of MgO; 0.1% by weight of ZrO₂; 0.4% by weight of TiO₂.

The batch was then mixed with binders in the form of 1.92% by weight of sodium hexametaphosphate as well as 0.38% by weight of sodium bisulphate, respectively with respect to the total weight of the batch without the binders, blended with water and sprayed as a gunning mass onto the surface of a tap hole of a converter.

When the converter was used, the gunning mass was heated to a temperature of 1600° C., whereupon the gunning mass underwent ceramic firing and the gunning mass was sintered to form a refractory ceramic product.

The refractory ceramic product obtained had the following physical properties, respectively determined in accordance with the standards mentioned above:

hot bending strength: 0.9 N/mm²;

bending strength: 7.0 N/mm²;

cold compression strength: 24.0 N/mm²;

linear change of length: −0.13 linear %.

1. A batch for manufacturing a refractory ceramic product, comprising the following components in the following proportions by weight, respectively with respect to the total weight of the product:
50% to 99.5% by weight of fused magnesia;
0 to 50% by weight of sintered magnesia;
0.5% to 5% by weight of a chromium oxide component in the form of at least one raw material based on Cr₂O₃; wherein
at least 90% by weight of the chromium oxide component has a grain size of at most 50 μm, with respect to the total weight of the chromium oxide component.

2. The batch as claimed in claim 1, wherein at least 90% by weight of the fused magnesia has a maximum grain size of 5.0 mm with respect to the total weight of the fused magnesia.

3. The batch as claimed in claim 1, with a chromium oxide component in the form of at least one of the following chromium oxide raw materials: ultrapure synthetic chromium oxide raw material or chromium oxide raw material with a proportion of Cr₂O₃ of at least 90% by weight with respect to the chromium oxide raw material.

4. A method comprising:
providing a batch, wherein the batch comprises the following components in the following proportions by weight, respectively with respect to the total weight of the product:
50% to 99.5% by weight of fused magnesia;
0 to 50% by weight of sintered magnesia;
0.5% to 5% by weight of a chromium oxide component in the form of at least one raw material based on Cr₂O₃; wherein
at least 90% by weight of the chromium oxide component has a grain size of at most 50 μm, with respect to the total weight of the chromium oxide component; and
applying the batch to a surface.

5. A method for manufacturing a refractory ceramic product, having the following characteristics:
providing a batch, wherein the batch comprises the following components in the following proportions by weight, respectively with respect to the total weight of the product:
50% to 99.5% by weight of fused magnesia;
0 to 50% by weight of sintered magnesia;
0.5% to 5% by weight of a chromium oxide component in the form of at least one raw material based on Cr₂O₃; wherein
at least 90% by weight of the chromium oxide component has a grain size of at most 50 μm, with respect to the total weight of the chromium oxide component;
shaping the batch; and
firing the shaped batch to form a shaped refractory ceramic product.

6. The method of claim 4, wherein the batch undergoes ceramic firing after being applied to the surface and is fired to form a refractory ceramic product.

7. A refractory ceramic product manufactured by a method, the method comprising:
providing a batch, wherein the batch comprises the following components in the following proportions by weight, respectively with respect to the total weight of the product:
50% to 99.5% by weight of fused magnesia;
0 to 50% by weight of sintered magnesia;
0.5% to 5% by weight of a chromium oxide component in the form of at least one raw material based on Cr₂O₃; wherein
at least 90% by weight of the chromium oxide component has a grain size of at most 50 μm, with respect to the total weight of the chromium oxide component shaping the batch; and
firing the shaped batch to form a shaped refractory ceramic product.

8. A method comprising:
using a batch as a refractory gunning mass or casting mass, wherein the batch comprises the following components in the following proportions by weight, respectively with respect to the total weight of the product:
50% to 99.5% by weight of fused magnesia;
0 to 50% by weight of sintered magnesia;
0.5% to 5% by weight of a chromium oxide component in the form of at least one raw material based on Cr₂O₃; wherein
at least 90% by weight of the chromium oxide component has a grain size of at most 50 μm, with respect to the total weight of the chromium oxide component.
